(19) United States
(12) Patent Application Publication
(10) Pub. No.: US 2020/0327263 A1
(43) Pub. Date: Oct. 15, 2020

(54) HIGH-PRECISION TRANSIENT ENERGY RESPONSE PREDICTION METHOD FOR COMPLEX STRUCTURE

(71) Applicant: SOUTHEAST UNIVERSITY, Nanjing (CN)

(72) Inventors: Qingguo FEI, Nanjing (CN); Qiang CHEN, Nanjing (CN); Yanbin LI, Nanjing (CN); Shaoqing WU, Nanjing (CN); Xuan YANG, Nanjing (CN); Pan WANG, Nanjing (CN)

(73) Assignee: SOUTHEAST UNIVERSITY, Nanjing (CN)

(21) Appl. No.: 16/652,986

(22) PCT Filed: Apr. 18, 2018
(86) PCT No.: PCT/CN2018/083485

§ 371 Date: Apr. 2, 2020

(30) Foreign Application Priority Data
Oct. 19, 2017 (CN) 201710981468.7

(51) Int. Cl. G06F 30/20; G06F 30/10

(52) U.S. Cl. CPC G06F 30/20; G06F 2111/10; G06F 30/10

(57) ABSTRACT

A high-precision transient energy response prediction method for a complex structure, including: taking a time dependent term (formula I) of energy transfer between subsystems into account; establishing a transient power balance equation of each subsystem of the structure by combining with a loss factor matrix η n of the complex structure; and given initial boundary parameters, adopting fourth-order and fifth-order Runge-Kutta algorithms to calculate transient energy response of each subsystem of the structure. The present invention establishes a more complete transient energy balance equation for each subsystem of the complex structure by taking the time dependent term of energy transfer between the subsystems of the complex structure into account, thereby significantly improving the prediction precision of the current transient statistical energy analysis method in the transient energy response prediction, and expanding the research scope of the current transient statistical energy analysis method.

### CROSS REFERENCE TO THE RELATED APPLICATIONS

This application is the national phase entry of International Application No. PCT/CN2018/083485, filed on Apr. 18, 2018, which is based upon and claims priority to Chinese Patent Application No. 201710981468.7, filed on Oct. 19, 2017, the entire contents of which are incorporated herein by reference.

### TECHNICAL FIELD

The present invention relates to a statistical energy analysis method and in particular to a transient energy response prediction method.

### BACKGROUND

Engineering structures are usually subjected to impact loads, such as rocket separation load, aircraft landing, ships impacted by ocean waves, and so on. The impact load has an important impact on the safe and reliable operation of the structure, and accurately predicting the dynamic response of the structure under the impact load is of great significance to the structural design. The frequency range of the impact load can be up to 10,000 Hz, which has obvious broadband characteristics. Due to shortcomings of using discretization methods to analyze the dynamic response of the structure at high frequency bands, such as high requirements for a grid size and sensitivity to calculation parameters, the energy based method is usually used to characterize the response of the structure under broadband loads, and the statistical energy analysis method is one of the most commonly used methods.

At present, the more commonly used transient energy response prediction method is the transient statistical energy analysis method. This method considers a transient term that the subsystem energy varies with time in the power balance equation, and realizes an application of the statistical energy analysis in the transient energy response prediction. However, the transient statistical energy response analysis method has problems such as low prediction precision and narrow application range, which can only be consistent with the prediction results of exact solutions in general trends, and especially in peak time and peak energy, the transient statistical energy response analysis method is quite different from the prediction result of the exact solution. With the ever-increasing precision requirements for the transient energy response prediction of the structure in practical engineering, the transient statistical energy response analysis method has been unable to meet the requirements of engineering design. Therefore, it is of very important engineering application value to propose a high-precision transient energy response prediction method for a complex structure.

### SUMMARY

Objective of the invention: in view of the shortcomings of the prior art, an objective of the present invention is to provide a high-precision transient energy response prediction method for a complex structure, to solve the problems that the current method has low prediction precision and narrow application range.

Technical solution: the present invention provides a high-precision transient energy response prediction method for a complex structure, including the following steps:

(1) establishing a statistical energy analysis model according to a geometric model of the structure, dividing the statistical energy analysis model into a plurality of subsystems, and defining a mode group considered for calculation in each subsystem;

(2) setting material parameters of the structure to calculate internal loss factors of the subsystems and coupling loss factors between the subsystems in different frequency bands, and assembling the internal loss factors and the coupling loss factors into a loss factor matrix η;

(3) based on an energy density control equation, taking a time dependent term

$$( \frac{{d}^{2} E ( t )}{d {t}^{2}} + \frac{d E ( t )}{d t} )$$

of an energy transfer between the subsystems into account, establishing a transient power balance equation of each subsystem of the structure by combining with the loss factor matrix η of the complex structure:

$$\frac{{d}^{2} E ( t )}{d {t}^{2}} + 2 \frac{d E ( t )}{d t} + ω η E ( t ) = P ( t )$$

wherein, ω is a center frequency of an analysis band, E(t)=[E₁(t), E₂ (t), . . . E_{N} (t)]^{T} is an energy matrix of the subsystems, Eᵢ (t) is an energy of a subsystem i as a function of a time t, P(t)=[P₁(t), P₂(t), . . . P_{N}(t)]^{T} is an input power matrix of the subsystems, and Pᵢ(t) is an input power of the subsystem i as a function of the time t; and

(4) given initial boundary parameters, adopting fourth-order and fifth-order Runge-Kutta algorithms to calculate the transient energy response of each subsystem of the structure.

Further, in step (1), the model is divided into plate-shell type subsystems (a flat plate, a curved plate and so on), beam subsystems (a straight beam, a ring beam and so on), and acoustic cavity subsystems according to geometric characteristics, wherein, only out-of-plane bending modes of the plate-shell type subsystem are taken into account, two sets of bending modes of the beam subsystem which are perpendicular to an axial plane are taken into account, and all modes of the acoustic cavity subsystem are taken into account.

Further, in step (2), by setting material parameters of the structure and an internal loss factor ηᵢ of the subsystem i, a coupling loss factor ηᵢⱼ between the subsystem i and a subsystem j, and a coupling loss factor ηⱼᵢ between the subsystem j and the subsystem i in different frequency bands are calculated according to a statistical energy analysis software, and are assembled into the loss factor matrix η, and for a structure with N subsystems, loss factor matrix elements of the structure with N subsystems are as follows:

$$η ( i , j ) = \{ \begin{matrix}{η}_{i} + {\sum }_{j \neq i}^{N} {η}_{ij} , i = j \\ - {η}_{ji} , i \neq j\end{matrix} .$$

Further, the energy density control equation in step (3) is:

$$\frac{\partial e}{\partial t} + ∇ \cdot I + {P}_{diss} = 0$$

wherein, e is an energy density,

$$\frac{\partial e}{\partial t}$$

is a time dependent term of the energy density, ∇·I is an energy transfer term between the subsystems, I is a power flow, and P_{diss} is an energy loss term;

I=ce, and P_{diss}=ωηe are substituted into the energy density control equation, wherein, c is a speed of a wave in the system, η is a structural damping loss factor, and then the power flow I is expressed by:

$$I = - \frac{{c}^{2}}{η ω} ∇ e - \frac{I}{ηω} \frac{\partial I}{\partial t}$$

an expression of the energy density of the subsystem can be obtained as follows by substituting a differential of the I into an energy control equation:

$$\frac{{\partial }^{2} e}{\partial {t}^{2}} + 2 \frac{\partial e}{\partial t} + ω η e - \frac{{c}^{2}}{ω η} {∇}^{2} e = 0$$

then a transient energy balance equation of the subsystem can be obtained as follows by integrating the expression of the energy density of the subsystem in space:

$$\frac{{d}^{2} E ( t )}{d {t}^{2}} + 2 \frac{d E ( t )}{d t} + ω η E ( t ) = P ( t ) .$$

In a traditional transient statistical energy analysis, the expression of the energy density of the subsystem is:

$$\frac{\partial e}{\partial t} + ω η e - \frac{{c}^{2}}{ω η} {∇}^{2} e = 0$$

In the traditional transient statistical energy analysis method, the transient energy balance equation of the subsystem is:

$$\frac{d E ( t )}{d t} + ω η E ( t ) = P ( t )$$

Comparing the traditional transient statistical energy analysis method with the present invention, it can be seen that the present invention takes the time dependent term

$$( \frac{{d}^{2} E ( t )}{d {t}^{2}} + \frac{d E ( t )}{d t} )$$

of the energy transfer between the subsystems into account, that is, the energy transfer between the subsystems is related to the energy of the subsystem and the energy gradient of the subsystem. Therefore, the method of the present invention has better calculation precision.

Further, in step (4), given the initial boundary parameters of the each subsystem of the structure, i.e. an initial energy E₁(0), E₂(0), . . . E_{N}(0) at time t=0 and an input power P(t), a solution time is set, and the fourth-order and fifth-order Runge-Kutta algorithms are adopted to solve a system of ordinary differential linear equations composed of the transient power balance equation, to calculate the transient energy response of each subsystem of the structure.

Advantages: compared with a traditional method only taking the time dependent term of energy into account, the present invention establishes a more complete transient energy balance equation for each subsystem of the complex structure by taking the time dependent term of energy transfer between the subsystems of the complex structure into account, thereby significantly improving the prediction precision of the current transient statistical energy analysis method in the transient energy response prediction, and expanding the research scope of the current transient statistical energy analysis method, which can solve the transient energy response analysis of a structure with different coupling intensities, and at the same time, can solve the transient energy response prediction problem of the complex structure by combining with a commercial statistical energy analysis software.

### BRIEF DESCRIPTION OF THE DRAWINGS

FIG. 1 is a schematic diagram of a structural subsystem in a geometric model of a complex structure of an embodiment;

FIG. 2 is a schematic diagram of an acoustic cavity subsystem in a geometric model of the complex structure of the embodiment;

FIG. 3 is a schematic diagram showing changes in energy over time of partial structural subsystems of the complex structure of the embodiment;

FIG. 4 is a schematic diagram showing changes in energy over time of the acoustic cavity subsystem of the complex structure of the embodiment;

FIG. 5 is a schematic diagram of a dual-oscillator model of a comparative example;

FIG. 6 is a schematic diagram of a statistical energy analysis model of a dual subsystem of the comparative example; and

FIG. 7 is a schematic diagram showing changes in energy over time of the oscillator 2 and the subsystem 2 of the comparative example.

### DETAILED DESCRIPTION OF THE EMBODIMENTS

The technical solution of the present invention is described in detail below, but the protective scope of the present invention is not limited to the embodiments described.

Embodiment: a high-precision transient energy response prediction method for a complex structure, wherein a fairing with a complex structure is selected as an analysis object, and specific operations are as follows:

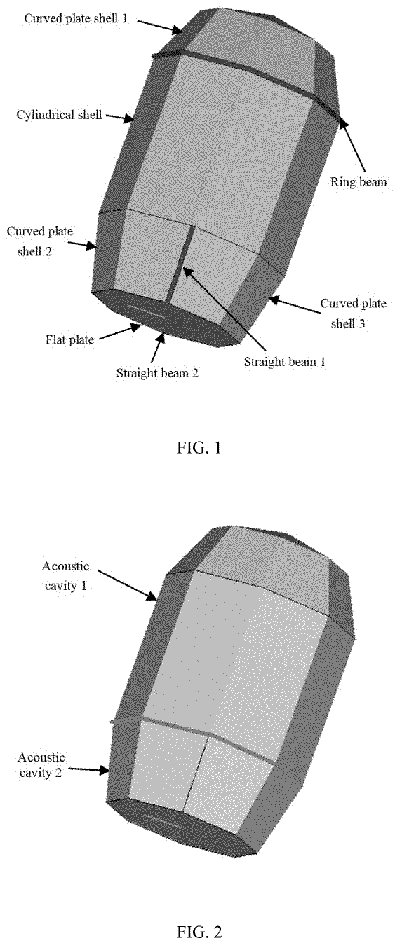

(1) The fairing is divided into the curved plate shell 1 subsystem, the curved plate shell 2 subsystem, the curved plate shell 3 subsystem, the cylindrical shell subsystem, the flat plate subsystem, the straight beam 1 subsystem, the straight beam 2 subsystem, the ring beam subsystem, the acoustic cavity 1 subsystem, and the acoustic cavity 2 subsystem according to geometric characteristics. The division of the structural subsystem and the acoustic cavity subsystem is as shown in FIGS. 1 and 2. Specifically, the solid black line in FIG. 1 represents the beam, including the straight beam 1, the straight beam 2 located at a position opposite to the straight beam 1, and the ring beam. The plane where the solid gray line is located in FIG. 2 is an interface between the acoustic cavity 1 and the acoustic cavity 2.

Mode groups considered for calculation in each subsystem are defined. The curved plate shell 1 subsystem, the curved plate shell 2 subsystem, the curved plate shell 3 subsystem, the cylindrical shell subsystem, and the flat plate subsystem only consider their out-of-plane bending modes, the straight beam 1 subsystem, the straight beam 2 subsystem, and the ring beam subsystem consider their two sets of bending modes perpendicular to an axial plane, and the acoustic cavity 1 subsystem and the acoustic cavity 2 subsystem consider all of their modes. Therefore, the structure is divided into 11 structural subsystems and 2 acoustic cavity subsystems, i.e. a total of 13 subsystems.

(2) The material of the structure of the fairing is aluminum with a density of 2700 kg/m³, an elastic modulus of 71 Gpa, and a Poisson's ratio of 0.33. The internal loss factor of the subsystem is set to 0.01 and the analysis frequency is set to 1000 Hz. The coupling loss factor in the ⅓ octave of the center frequency of 1000 Hz is calculated by a commercial statistical energy analysis software and is assembled into a loss factor matrix η.

(3) A transient power balance equation of each subsystem of the structure is established:

$$\frac{{d}^{2} E ( t )}{d {t}^{2}} + 2 \frac{d E ( t )}{d t} + ω η E ( t ) = P ( t )$$

wherein: E(t)=[E₁(t), E₂(t), . . . E₁₃(t)]^{T} is a subsystem energy matrix, P(t)=[P₁(t), P₂(t), . . . P₁₃(t)]^{r} is a subsystem input power matrix, and ω=2π×1000 rad/s=6283.18 rad/s.

(4) Given initial boundary parameters, fourth-order and fifth-order Runge-Kutta algorithms are adopted to calculate the transient energy response of each subsystem of the structure.

The initial boundary conditions: E(0)=[E₁(0), E₂(0), . . . E₁₃(0)]^{T}=[1, 0, . . . 0]^{T}, and P(t)=[P₁(t), P₂(t), . . . P₁₃(t)]^{T}=[0, 0 . . . 0]^{T} are substituted, the solution time is set to 1 s, the fourth-order and fifth-order Runge-Kutta algorithms are adopted to solve, and partial subsystem of the structure are selected for display.

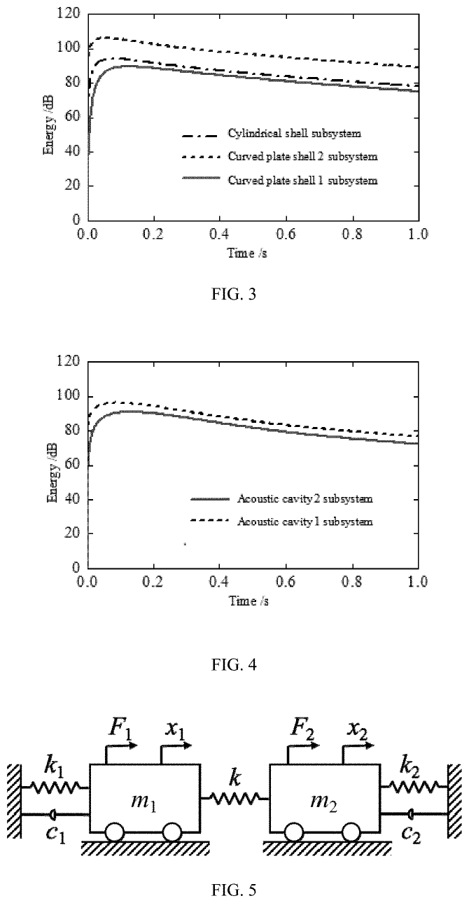

A schematic diagram of changes in energy over time of the cylindrical shell subsystem, the curved plate shell 2 subsystem, and the curved plate shell 1 subsystem as shown in FIG. 3 is obtained, wherein the energy is expressed in dB and the reference energy value is 10⁻¹² J. It can be seen from FIG. 3 that the energy peak times of the cylindrical shell subsystem, the curved plate shell 2 subsystem, and the curved plate shell 1 subsystem are 0.045 s, 0.032 s, and 0.077 s respectively, and the energy peak values of the cylindrical shell subsystem, the curved plate shell 2 subsystem, and the curved plate shell 1 subsystem are 92.2 dB, 106 dB, and 85.9 dB, respectively.

A schematic diagram of changes in energy over time of the acoustic cavity 1 subsystem and the acoustic cavity 2 subsystem as shown in FIG. 4 is obtained, wherein the energy is expressed in dB and the reference energy value is 10⁻¹² J. It can be seen from FIG. 4 that the energy peak times of the acoustic cavity 1 subsystem and the acoustic cavity 2 are 0.03 s and 0.024 s, respectively, and the energy peak values of the acoustic cavity 1 subsystem and the acoustic cavity 2 subsystem are 84.3 dB and 91.3 dB, respectively.

Comparative example: as shown in FIG. 5, a dual-oscillator model with an exact theoretical solution is selected to carry out predictive precision analysis by different methods. The simulation parameters used in the exact solution are as follows: the mass m₁ of the oscillator 1 and the mass m₂ of the oscillator 2 are 2 kg; the damping c₁ of the oscillator 1 and the damping c₂ of the oscillator 2 are 0.2 N·s; the stiffness k₁ of the spring 1 and the stiffness k₂ of the spring 2 are 17.17×10⁵ N/m; the coupling stiffness k between the oscillators is 2.8×10⁵ N/m; the initial displacement x₁(0) of the oscillator 1 is 0, and the initial displacement x₂(0) of oscillator 2 is 0; the initial velocity v₁(0) of the oscillator 1 is 1 m/s, that is, the initial energy E₁(0) of the oscillator 1 is 1 J; the initial velocity v₂(0) of the oscillator 2 is 0, that is, the initial energy E₂(0) of the oscillator 2 is 0; and the external force acting on the oscillator 1 is F₁(t)=0, and the external force acting on the oscillator 2 is F₂(t)=0.

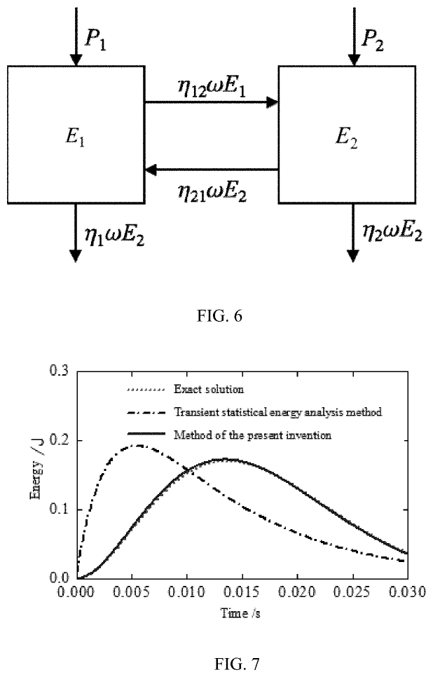

In the statistical energy analysis, the dual-oscillator model is converted into a two-subsystem statistical energy analysis model as shown in FIG. 6, wherein the oscillator 1 corresponds to the subsystem 1, and the oscillator 2 corresponds to the subsystem 2. It is defined so that the internal loss factor of the subsystem 1 and the internal loss factor η₂ of the subsystem 2 each are 0.1, the coupling loss factor η₁₂ between the subsystem 1 and the subsystem 2 is 0.1, the coupling loss factor η₂₁ between the subsystem 2 and the subsystem 1 is 0.1, the initial energy E₁(0) of the subsystem 1 is 1 J, the initial energy E₂(0) of the subsystem 2 is 0, the input power P₁(t) of subsystem 1 is 0, and the input power P₂(t) of subsystem 2 is 0.

\textcircled{1} For an exact theoretical solution, the calculated time-varying curve of the energy of the oscillator 2 in 0˜0.03 s is as shown by the dotted line in FIG. 7.

In the dual-subsystem statistical energy analysis method: the oscillation energy is E(t)=[E₁(t), E₂(t)]^{T}, the input power is P(t)=[P₁(t), P₂(t)]^{T}, and the loss factor matrix η is expressed by:

$$η = [ \begin{matrix}0.2 & - 0.1 \\ - 0.1 & 0.2\end{matrix} ]$$

\textcircled{2} For the traditional transient statistical energy analysis method, the power balance equation is:

$$\frac{d E ( t )}{d t} + ω η E ( t ) = P ( t )$$

The initial boundary conditions: E₁(0)=1, E₂(0)=0, P₁(t)=0, and P₂(t)=0 are substituted, the solution time is set to 0.03 s, and the fourth-order and fifth-order Runge-Kutta algorithms are adopted to solve the power balance equation, obtaining the time-varying curve of the energy of the oscillator 2 as shown by the chain-dotted line in FIG. 7.

\textcircled{3} For the high-precision transient energy response prediction method for the complex structure according to the present invention, the power balance equation is:

$$\frac{{d}^{2} E ( t )}{d {t}^{2}} + 2 \frac{d E ( t )}{d t} + ω η E ( t ) = P ( t )$$

The initial boundary conditions: E₁(0)=1, E₂(0)=0, P₁(t)=0, and P₂(t)=0 are substituted, the solution time is set to 0.03 s, and the fourth-order and fifth-order Runge-Kutta algorithms are adopted to solve the power balance equation, obtaining the time-varying curve of the energy of the oscillator 2 as shown by the solid line in FIG. 7.

It can be seen from the results in FIG. 7 that compared with the traditional transient statistical energy analysis method, the present invention has better consistency with the exact theoretical solution, can better capture the peak time and peak energy of the energy change of the oscillator 2, and has higher calculation precision.

What is claimed is:

1. A high-precision transient energy response prediction method for a complex structure, comprising the following steps:
(1) establishing a statistical energy analysis model according to a geometric model of the complex structure, dividing the statistical energy analysis model into a plurality of subsystems, and defining a mode group considered for calculation in each subsystem of the plurality of subsystems;
(2) setting a plurality of material parameters of the complex structure to calculate a plurality of internal loss factors of the plurality of subsystems and a plurality of coupling loss factors between the plurality of subsystems in a plurality of different frequency bands, and assembling the plurality of internal loss factors and the plurality of coupling loss factors into a loss factor matrix η;
(3) based on an energy density control equation, taking a time dependent term
$$( \frac{{d}^{2} E ( t )}{d {t}^{2}} + \frac{d E ( t )}{d t} )$$
of an energy transfer between the plurality of subsystems into account, establishing a transient power balance equation of each subsystem of the complex structure by combining with the loss factor matrix η of the complex structure:
$$\frac{{d}^{2} E ( t )}{d {t}^{2}} + 2 \frac{d E ( t )}{d t} + ω η E ( t ) = P ( t )$$
wherein, ω is a center frequency of an analysis band, E(t)=[E₁(t), E₂(t), . . . E_{N} (t)]^{T} is an energy matrix of the plurality of subsystems, Eᵢ(t) is an energy of a subsystem i as a function of a time t, P(t)=[P₁(t), P₂ (t), . . . P_{N} (t)]^{T} is an input power matrix of the plurality of subsystems, and Pᵢ(t) is an input power of the subsystem i as a function of the time t; and
(4) given a plurality of initial boundary parameters, adopting fourth-order and fifth-order Runge-Kutta algorithms to calculate a transient energy response of each subsystem of the complex structure.

2. The high-precision transient energy response prediction method for the complex structure according to claim 1, wherein: in step (1), the statistical energy analysis model is divided into a plate-shell type subsystem, a beam subsystem, and an acoustic cavity subsystem according to geometric characteristics, wherein, only an out-of-plane bending mode of the plate-shell type subsystem is taken into account, two sets of bending modes of the beam subsystem are taken into account, wherein the two sets of bending modes are perpendicular to an axial plane, and all modes of the acoustic cavity subsystem are taken into account.

3. The high-precision transient energy response prediction method for the complex structure according to claim 1, wherein: in step (2), by setting the plurality of material parameters of the complex structure and an internal loss factor ηᵢ of the subsystem i, a coupling loss factor ηᵢⱼ between the subsystem i and a subsystem j, and a coupling loss factor ηⱼᵢ between the subsystem j and the subsystem i in the plurality of different frequency bands are calculated according to a statistical energy analysis software, and the coupling loss factor ηⱼᵢ and the coupling loss factor ηⱼᵢ are assembled into the loss factor matrix η, and for the complex structure with N subsystems, loss factor matrix elements of the complex structure with N subsystems are as follows:
$$η ( i , j ) = \{ \begin{matrix}{η}_{i} + {\sum }_{j \neq i}^{N} {η}_{ij} , i = j \\ - {η}_{ji} , i \neq j\end{matrix} .$$

4. The high-precision transient energy response prediction method for the complex structure according to claim 1, wherein: the energy density control equation in step (3) is:
$$\frac{\partial e}{\partial t} + ∇ \cdot I + {P}_{diss} = 0$$
wherein, e is an energy density,
$$\frac{\partial e}{\partial t}$$
is a time dependent term of the energy density, ∇·I is an energy transfer term between the plurality of subsystems, I is a power flow, and P_{diss} is an energy loss term;
I=ce, and P_{diss}=ωηe are substituted into the energy density control equation, wherein, c is a speed of a wave in the complex system, η is a structural damping loss factor, and then the power flow I is expressed by:
$$I = - \frac{{c}^{2}}{η ω} ∇ e - \frac{1}{ηω} \frac{\partial I}{\partial t}$$
an expression of the energy density of each subsystem is obtained as follows by substituting a differential of the I into the energy density control equation:
$$\frac{{\partial }^{2} e}{\partial {t}^{2}} + 2 \frac{\partial e}{\partial t} + ω η e - \frac{{c}^{2}}{ω η} {∇}^{2} e = 0$$
then a transient energy balance equation of each subsystem is obtained as follows by integrating the expression of the energy density of each subsystem in space:
$$\frac{{d}^{2} E ( t )}{d {t}^{2}} + 2 \frac{d E ( t )}{d t} + ω η E ( t ) = P ( t ) .$$

5. The high-precision transient energy response prediction method for the complex structure according to claim 1, wherein: in step (4), given the plurality of initial boundary parameters of each subsystem of the complex structure, wherein the plurality of initial boundary parameters comprises an initial energy E₁(0), E₂(0), . . . E_{N}(0) at time t=0 and an input power P(t), a solution time is set, and the fourth-order and fifth-order Runge-Kutta algorithms are adopted to solve a system of ordinary differential linear equations composed of the transient power balance equation, to calculate the transient energy response of each subsystem of the complex structure.
